(19) United States
(12) Patent Application Publication
(10) Pub. No.: US 2006/0244180 A1
(43) Pub. Date: Nov. 2, 2006

(54) Mold pin and mold for its use

(76) Inventors: Syed Shabber Ali, Brampton (CA); James Scott, Cambridge (CA)

Correspondence Address: LATHROP & GAGE LC, 2345 GRAND AVENUE, SUITE 2800, KANSAS CITY, MO, 64108, US

(21) Appl. No.: 11/303,590

(22) Filed: Dec. 15, 2005

Related U.S. Application Data
(60) Provisional application No. 60/636,893, filed on Dec. 17, 2004.
(60) Provisional application No. 60/648,589, filed on Jan. 31, 2005.

(51) Int. Cl. B29C 41/04

(52) U.S. Cl. 264/310; 425/435

(57) ABSTRACT

A mold pin is formed of a longitudinally extending rod-like body with a collar extending laterally or transversely from the body. The collar is of peripheral and longitudinal dimensions similar to those of a protrusion extending from the surface of a mold tray (mold casting or half), such that when the mold pin seats in the protrusion, the protrusion and the collar define a boss in the mold tray.

### CROSS REFERENCES TO RELATED APPLICATIONS

This application is related to and claims priority from U.S. Provisional Patent Application No. 60/636,893, entitled: Mold Pin And Mold For Its Use, filed on Dec. 17, 2004, and U.S. Provisional Patent Application No. 60/648,589, entitled: Mold Pin And Mold For Its Use, filed on Jan. 31, 2005, both of these U.S. Provisional Patent Applications are incorporated by reference herein.

### FIELD OF THE INVENTION

The present invention is directed to rotational molding. In particular, the present invention is directed to pins used in rotational molds, and the molds, including their castings.

### BACKGROUND OF THE INVENTION

Rotational molding is a highly versatile manufacturing option. It allows for unlimited design possibilities with the added benefit of low production costs.

The rotational molding process starts with a good quality mold, that is typically formed in castings or halves, that define a mold cavity therein. The mold cavity is configured to the corresponding configuration of the desired component or product to be molded. The castings are placed together to form the mold, and the molds are placed into a molding machine that has a loading, heating, and cooling area.

Several molds, formed by the mold halves, may be placed on the machine at the same time. Pre-measured plastic resin is loaded into each mold, and then the molds are moved into the oven where they are slowly rotated on both the vertical and horizontal axis. The melting resin sticks to the hot mold and coats every surface evenly. The mold continues to rotate during the cooling cycle so the parts retain an even wall thickness.

Once the parts are cooled, they are released from the mold. The rotational speed, heating times, and cooling times, are all controlled throughout the process.

Rotational molding offers design advantages over other molding processes. With proper design, parts that are assembled from several pieces can be molded as one part, eliminating expensive fabrication costs.

The rotational molding process also has a number of inherent design strengths. These strengths include, consistent wall thickness and strong outside corners, that are virtually stress free. If additional strength is required, reinforcing ribs can be designed into the part.

Rotational molding delivers the product the designer envisions. Designers can select the best material for their application, including materials that meet governmental requirements. Additives to help make the part weather resistant, flame retardant, or static free can be specified.

Inserts, threads, handles, minor undercuts, and flat surfaces, that eliminate draft angles or fine surface detail, can all be part of the design. Designers also have the option of multi-wall molding, that can be either hollow or foam filled.

Rotational molding is cost effective. Tooling is less expensive in comparison to conventional molding processes, such as injection molding and blow molding, as an internal core is not manufactured. By lacking an internal core, minor changes can be made to an existing mold. Moreover, since the components are formed with by heat, coupled with rotation, as opposed to pressure, as with injection and blow molding, a greater selection of materials, including lightweight materials can be used. Such lightweight materials are not possible for use with the pressures of injection and blow molding, as these pressures limited these molding operations to heavyweight materials.

FIG. 1A shows a casting 20 or half (also known as a mold tray) of a conventional rotational mold, having a depression 21, corresponding to a portion of the desired part to be molded, impressed therein. The casting 20 is made of aluminum, and includes a boss 22 or elevated portion, protruding from the depression 21, that supports a steel pin 24. The pin 24 is a straight pin, utilized in the mold to create bores or holes in the molded component or product. This pin 24 extends from the boss 22, initially in a straight orientation.

FIG. 1B shows a correspondingly configured mold casting 20′ or half for use with the mold casting 20. The casting 20′ also includes a depression 21′, corresponding to the portion of the desired part to be molded. These two castings 20, 20′, when placed together, form the mold with a mold cavity therein.

As shown in greater detail in FIG. 2, the pin 24 is received in a bore or hole 28 in the boss 22. The bottom portion 24a of the pin 24 is threaded along its exterior 30, to be received by a nut 32, to hold the pin 24 in place. The boss 22 extends from the surface 20a of the casting 20, for example, to a height or longitudinal dimension indicated as “x”. The upper portion 24b of the pin 24 extends from the surface 22a of the boss 22.

While the castings 20, 20′ make up a single mold, multiple castings 20, 20′ are provided on racks 38, 38′ respectively, as shown in FIGS. 3A and 3B. When the racks 38, 38′ are coupled to form multiple molds, they are placed into a rotational mold apparatus or machine, for producing components or products in a single molding session.

However, this arrangement of the pin 24 in the casting 20 (in the boss 22) exhibits drawbacks. In particular, the pins 24 become bent or crooked over time. This results in products that are unsatisfactory and must be rejected. The pins 24 become bent by moving out of alignment, in a relatively short time, as early as approximately 100 cycles. Accordingly, after these approximately 100 cycles, the pins 24 have to be manually straightened, typically by being hit with a hammer or mallet. This straightening technique cannot ensure straightening of the pins 24, and after the pins 24 have been hit too many times, they must be replaced. Straightening or replacing the pins 24 involves labor costs. Additionally, during periods of pin straightening or replacement, the molds are out of service. This results in lost production, and other economic losses due to production delays.

### SUMMARY OF THE INVENTION

The present invention improves on the conventional art by providing a pin that does not require straightening over its usable life. It also provides a mold for use with this pin. The pin provides for increased heat transfer in the molding process. This increased heat transfer inhibits blow holes (also known as voids) from forming in the molded parts, such that the molded parts, resulting from the invention, include fewer, if any, blow holes, when compared to parts formed in conventional molds that use conventional mold pins. The pins also serves to increase wall thickness in the areas where they are located, also reducing the probability for blow hole or void formation. By reducing and eliminating conditions for blow hole formation, the rejection rate of completed parts is dramatically reduced.

As a result of this pin, mold production is more economical, as the number of rejected products is significantly reduced, and more products can be produced in a time period. This is because, the pins last longer than the conventional pins, and they do not require maintenance over their usable life. Moreover, the pins are releasable as a single unit, so that when one needs to be replaced, it can be easily unscrewed from its holder and easily replaced with another pin. The replacement pin, upon its installation, will be in a straight alignment.

The mold pin of the invention is formed of a longitudinally extending rod-like body with a collar extending laterally or transversely from the body. The collar is of peripheral and longitudinal dimensions similar to those of a protrusion extending from the surface of a mold tray (mold casting or half), such that when the mold pin seats in the protrusion, the protrusion and the collar define a boss in the mold tray.

An embodiment of the invention is directed to a boss for a mold tray (mold cavity or half), that combined with another correspondingly configured mold tray defines a mold cavity, in which the part is formed. The boss is formed of a first portion and a second portion. The first portion extends from the surface of a portion of a mold tray. The second portion includes a laterally extending segment of a mold pin. The mold pin has a longitudinal body supporting the laterally extending segment, for example, a collar that journals the body, and at least a portion of the longitudinal body (e.g., in a cylindrical rod-like shape) is received in the first portion of the boss.

Another embodiment of the invention is directed to a mold pin for receipt in a mold tray (mold casting or half). The mold pin has a longitudinally extending body of a rod-like shape (e.g., cylindrical), and the body has a first end and a second end. A segment, for example, a collar, extends laterally from the body and is positioned along the body intermediate the first end and the second end. The laterally extending segment forms at least a portion of a boss when the mold pin is received in the mold tray.

Another embodiment of the invention is directed to a mold system. The mold system includes at least one mold tray (mold casting or half) having a portion defining a portion of a mold cavity. At least one protrusion extends from the portion defining the portion of the mold cavity, and there is at least one mold pin. The mold pin has a longitudinally extending rod-like shaped body including a first portion and a second portion, and a laterally extending segment, extending from the body intermediate the first portion and the second portion. The second portion is such that it is at least temporarily received in the at least on protrusion. Additionally, the at least one protrusion and the laterally extending segment define at least one boss in the mold tray.

Another embodiment of the invention is directed to a method for producing a molded part. The method includes, providing a first mold tray and a second mold tray. The first mold tray includes, at least one portion defining a portion of a mold cavity, at least one protrusion extending from the portion of the tray defining a portion of the mold cavity, and, at least one mold pin. The mold pin includes, a longitudinally extending rod-like shaped body including a first portion and a second portion, and, a laterally extending segment, extending from the body intermediate the first portion and the second portion. The second portion is for being at least temporarily received in the at least one protrusion. The at least one protrusion and the laterally extending segment define at least one boss in the first mold tray. The second mold tray includes, a portion defining a portion of the mold cavity. The first mold tray and the second mold tray are placed into alignment to define the mold cavity, and to form a mold. Polymer powder is placed into the mold cavity of the mold, and, and the now filled mold is placed into a rotational molding apparatus to produce the molded part.

### BRIEF DESCRIPTION OF THE DRAWINGS

Attention is now directed to the drawing figures, where corresponding or like components are indicated by corresponding or like numbers or characters. In the drawings:

FIG. 1A is a top view of the cavity side of a mold casting in accordance with the conventional art;

FIG. 1B is a top view of the cavity side of a correspondingly configured mold casting for the mold casting of FIG. 1A, in accordance with the conventional art;

FIG. 2 is a cross sectional view of the boss and pin taken along line 2-2 of FIG. 1A;

FIGS. 3A and 3B are top views of correspondingly configured mold castings of FIGS. 1A and 1B respectively, for placement into a rotational mold apparatus;

FIG. 4 is a top view of the cavity side of a mold casting with the pins and bosses in accordance with an embodiment of the invention;

FIG. 5 is a cross sectional view of the boss and pin taken along line 5-5 of FIG. 4;

FIG. 6 is a perspective view of the pin in accordance with an embodiment of the invention;

FIG. 7 is a view of the mold cavity formed by the casting of FIG. 4 with a correspondingly configured mold casting; and

FIG. 8 is a perspective view of a product made from the mold castings in accordance with the embodiments of the present invention.

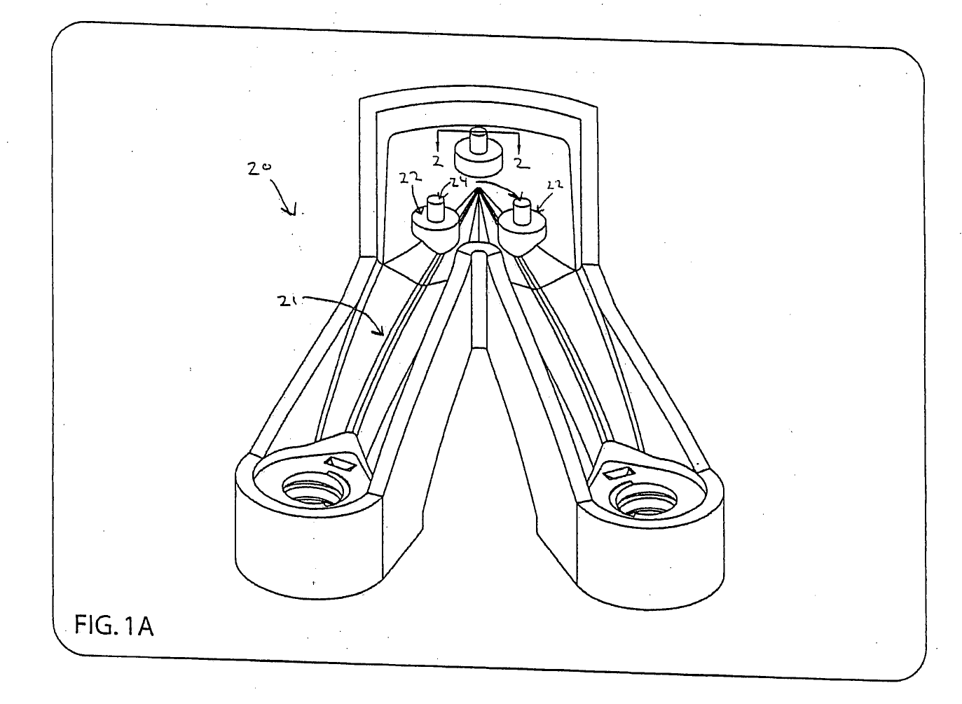

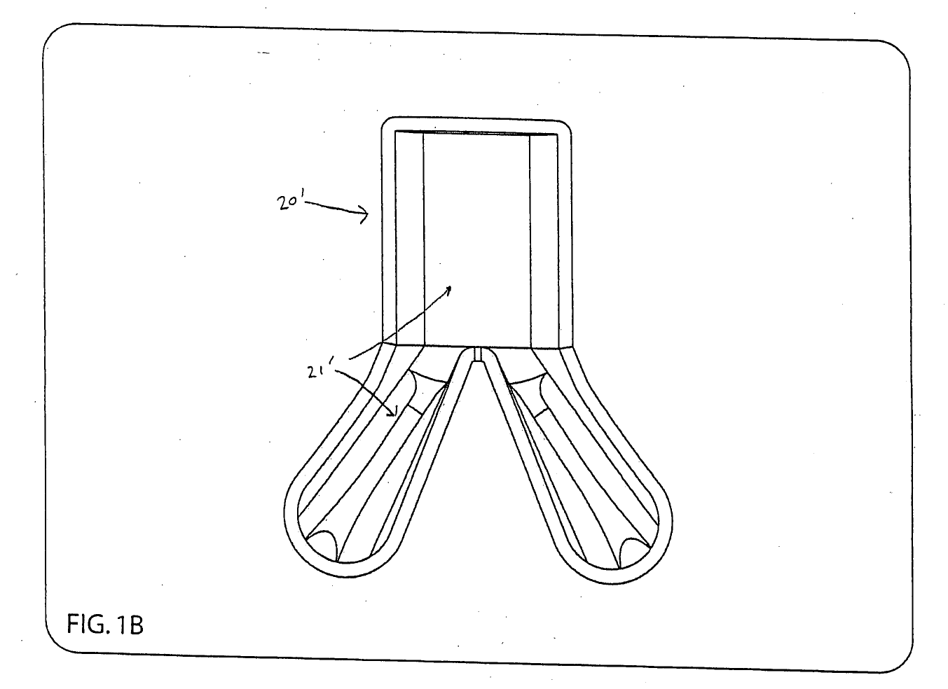

### DETAILED DESCRIPTION

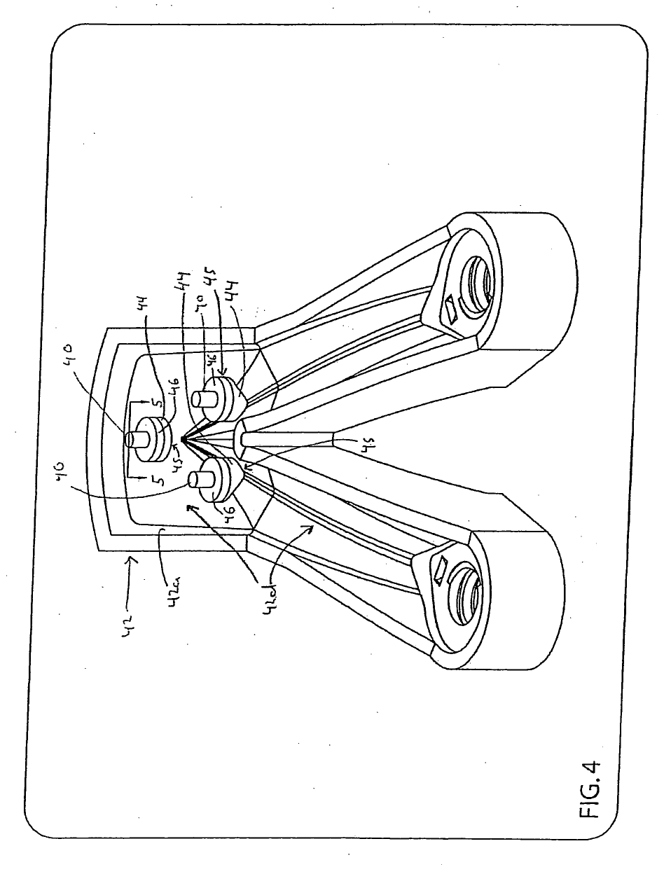

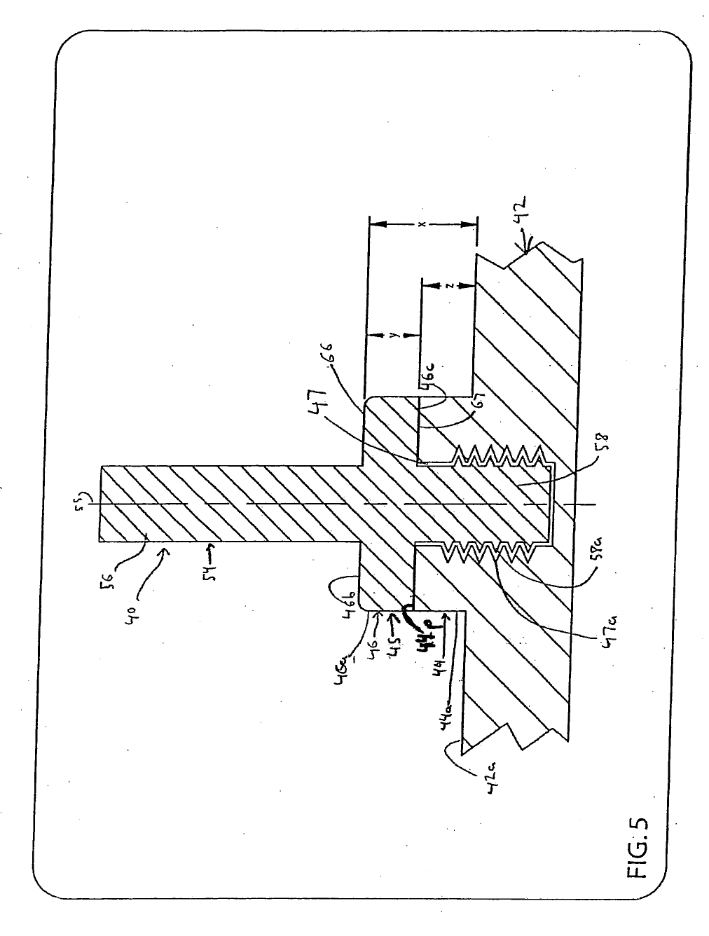

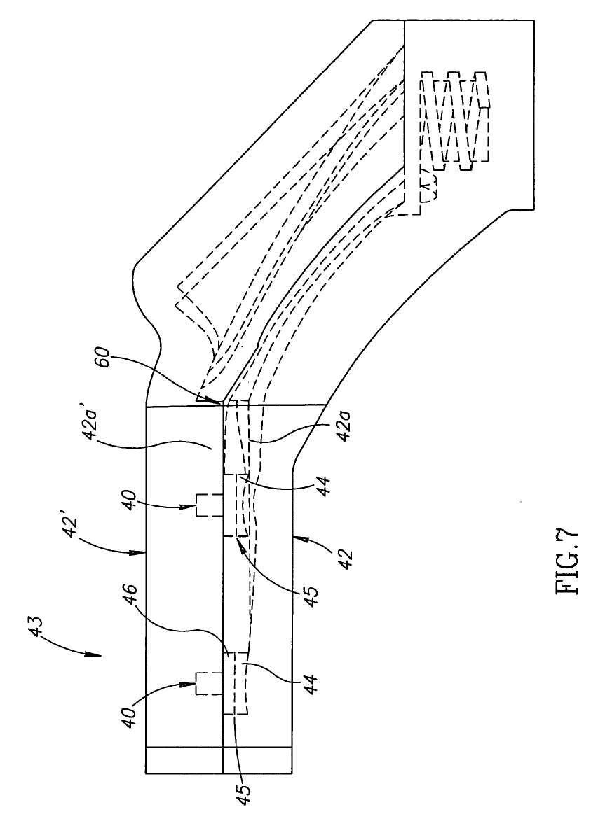

FIG. 4 shows an embodiment of the pin 40 of the present invention in a casting 42 or half (mold tray), of a mold 43 (FIG. 7), for example, for a rotational molding machine (apparatus). The casting 42 includes a surface 42a that defines a depression 42d (similar to depression 21), corresponding to a portion of the desired part to be molded, impressed therein. A protrusion 44 extends from the depression 42d in the casting 42, and its surfaces 44a and 44p (FIG. 5) are continuous with the surface 42a. The protrusion 44 is, for example, cylindrical in shape and of a circular cross section. The protrusion 44 forms a part of a boss 45, as the boss 45 is typically formed from two parts. While multiple bosses 45, formed of pins 40 and protrusions 44 are shown, the molds 43 may use one or more boss 45, such that the pin 40 and protrusion 44 are representative of all bosses 45, pins 40 and protrusions 44, in the mold 43.

The other part of the boss 45 is formed by a laterally extending collar segment or collar 46 of the pin 40. The pin 40 seats in the protrusion 44. This seating is such that the pin 40, mainly at its collar segment 46, is thermally coupled to the protrusion 44, and typically, the protrusion 44 and collar segment 46 of the pin 40 are in abutting contact. The pin 40, including its collar segment or collar 46, may be of a material with greater thermal conductivity than that of the protrusion 44 and the casting 42 (the casting 42 is an integral member including the protrusion 44), such that the pin 40 typically serves as a heat sink or the like.

A bore 47 (FIG. 5) extends through the casting portion of the boss 45 for receiving the pin 40, such that the pin 40 is in a “straight” orientation. The casting 42 is similar to the casting 20 (detailed above) except for the boss 45, as detailed herein.

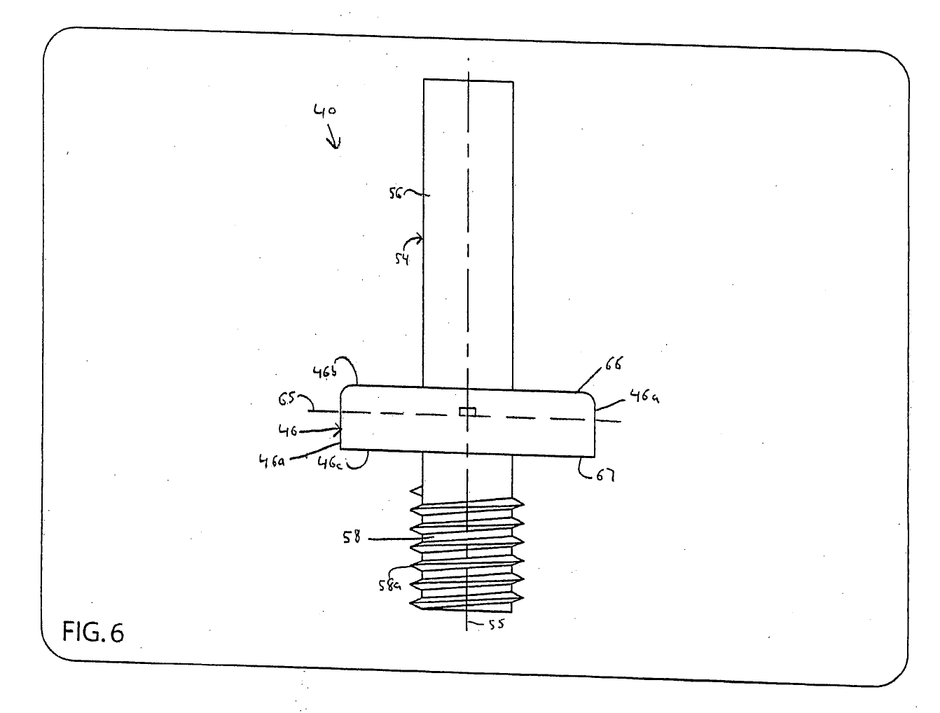

Turning also to FIGS. 5 and 6, the pin 40 includes a collar 46, that extends laterally (transversely) from the pin body 54. The pin body 54 is, for example, cylindrical and rod-like in shape and of a circular cross-section, and it extends longitudinally (along the longitudinal axis 55).

The pin body 54, at the collar 46, divides the pin 40 into a first portion 56 and a second portion 58. The first portion 56 is designed to extend into the mold cavity 60, when the mold castings 42, 42′ (the casting 42′ is correspondingly configured with respect to the casting 42), are combined, to form the mold 43. When the castings 42, 42′ (casting 42′ is similar to the casting 20′ above) are combined, they (the inner surfaces 42a, 42a′ of the respective castings 42, 42′) define the mold cavity 60 in the shape of the desired part, as shown in FIG. 7. Additionally, the first portion 56 of the pin 40 may be tapered outward, in a direction toward the collar 46, if desired.

The second portion 58 is threaded, along at least a portion 58a of it. The second portion 58 attaches in a screw-like manner to the bore 47, that is correspondingly threaded (along a portion 47a of it), in the protrusion 44. While this screw-like arrangement for pin 40 at its second portion 58, for retention in the bore 47 is preferred, other retention arrangements for the pin 40 and configurations of the second portion 58 of the pin 40 for engagement and retention in the bore 47 are also permissible.

The pins 40 are releasable as a single unit, so that when a pin 40 needs to be replaced, it can be unscrewed from the protrusion 44, and replaced with another pin 40. The replacement pin, upon its installation, will be in a straight alignment.

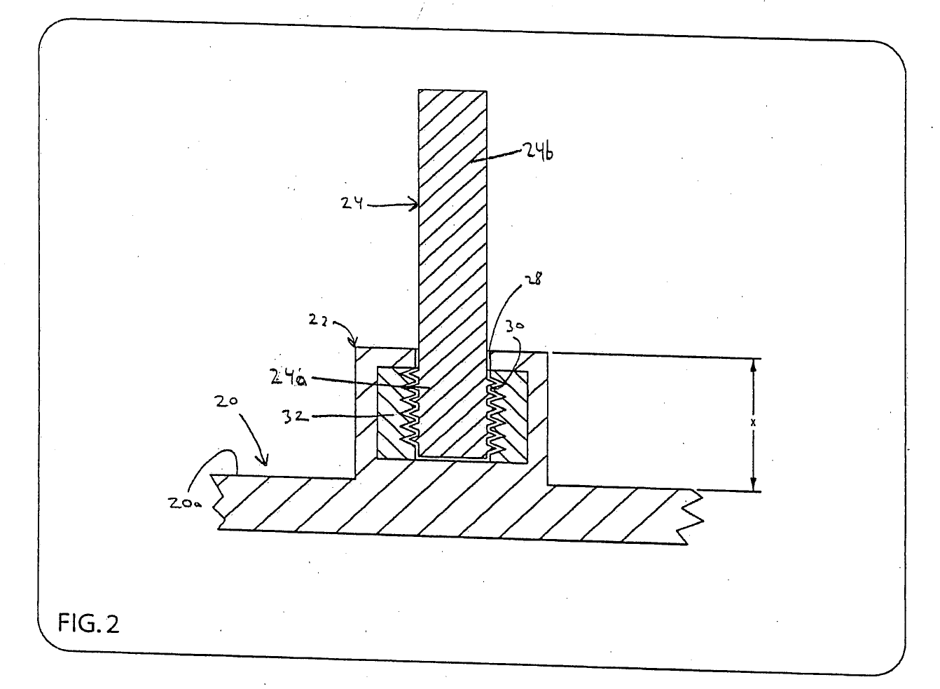

The pin 40 is preferably a single piece unitary member, typically formed by conventional metal working techniques and processes. The pin 40 is, for example, made of materials such as steel, for use with an aluminum casting 42 (the aluminum casting 42 including the protrusion 44 that a forms a part of the boss 45). The collar 46 (that forms the other part of the boss 45) is typically torroidal in shape (and for example, of a circular cross-section) and of a height or longitudinal dimension “y” that is, for example, at least approximately half of the protruding height “x” of the boss 22 of the conventional casting 20, as shown in FIG. 2. Accordingly, the protrusion 44 of the boss 45 is of a height (longitudinal dimension) “z” from the surface 42a of the casting 42, this height “z” forming the other half of the height (longitudinal dimension) “x”, the total height of the boss 45, as shown in FIG. 5. Alternately, for example, depending on the mold used, the height of the boss 45, can be any desired height, defined by the height (longitudinal dimension) of the protrusion 44 plus the longitudinal dimension of the collar 46 of the pin 40.

The collar 46, extends laterally along a transverse axis 65 (the transverse axis 65 is perpendicular to the longitudinal axis 55). The collar 46 is typically of a configuration corresponding to that of the protrusion 44, with its periphery 46a typically coincident or flush with the periphery (peripheral surface) 44a of the protrusion 44. The collar 46 also includes first 46b and second 46c surfaces on its upper 66 and lower 67 sides respectively (in a typical orientation). The collar 46 serves as a stop surface for the pin 40, limiting its travel (by the second portion 58 of the pin 40) into the bore 47 of the protrusion 44.

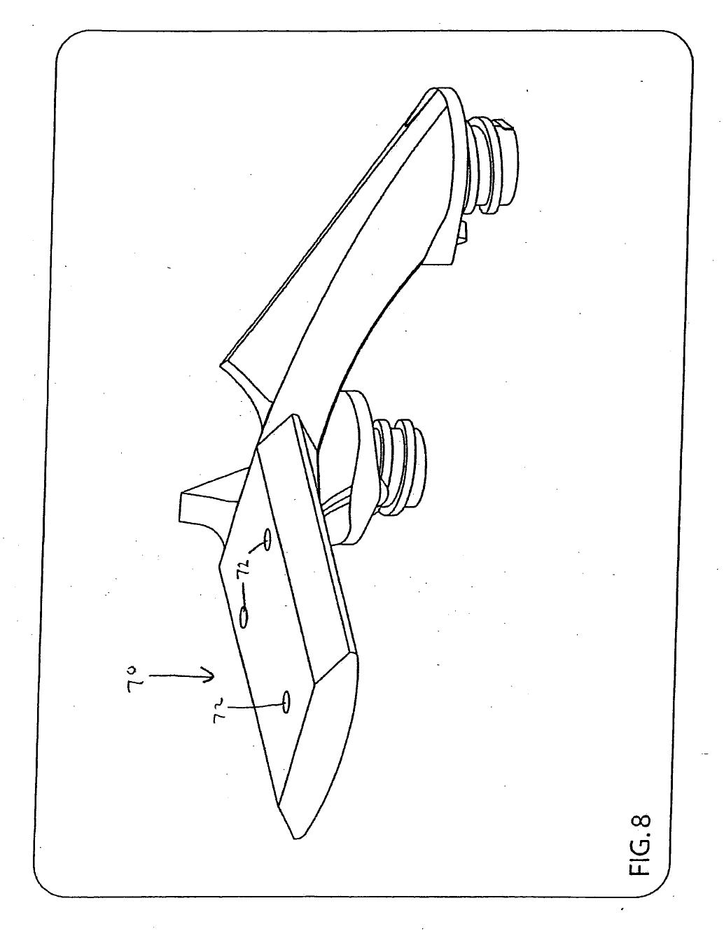

FIG. 8 shows a part or product 70 produced by a rotational molding process using a mold 43 formed from the castings 42 and 42′, as shown in FIG. 7. The part or product 70 includes openings 72 defined by the pins 40, as they were positioned in the mold cavity 60 (FIG. 7).

An exemplary operation, using a mold 43 of the present invention, formed from the castings 42 and 42′ with the pins 40 in the casting 42 (the corresponding and matching casting 42′ typically does not accommodate pins 40), is now detailed. This exemplary operation employing the mold 43, may be used for making a part or product similar to the part or product 70. In this exemplary operation, reference is made to FIGS. 4-8. This exemplary operation is conducted in accordance with standard rotational molding industry practice, except where noted below.

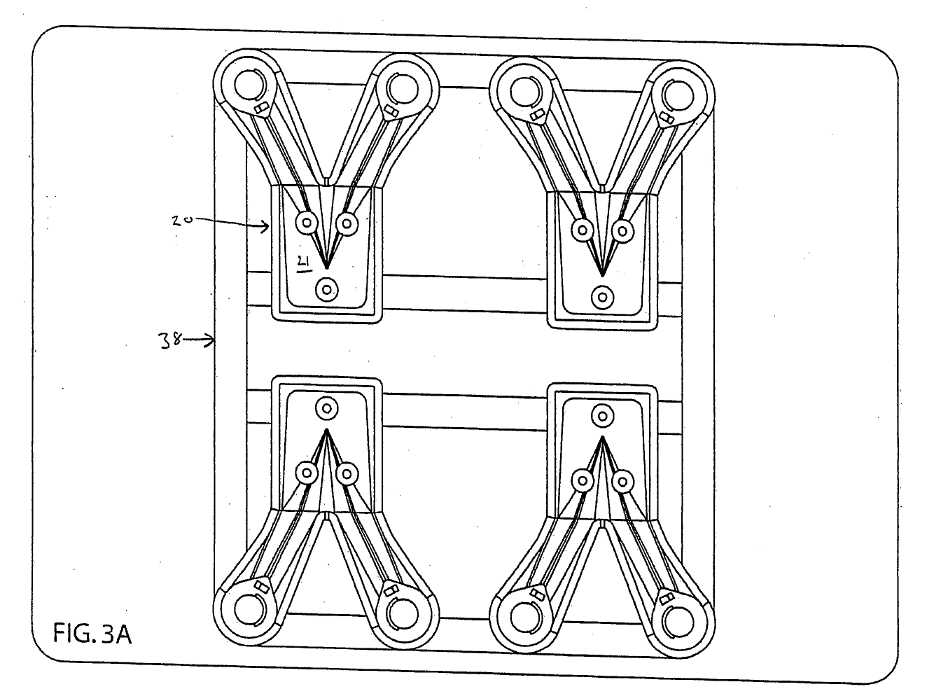

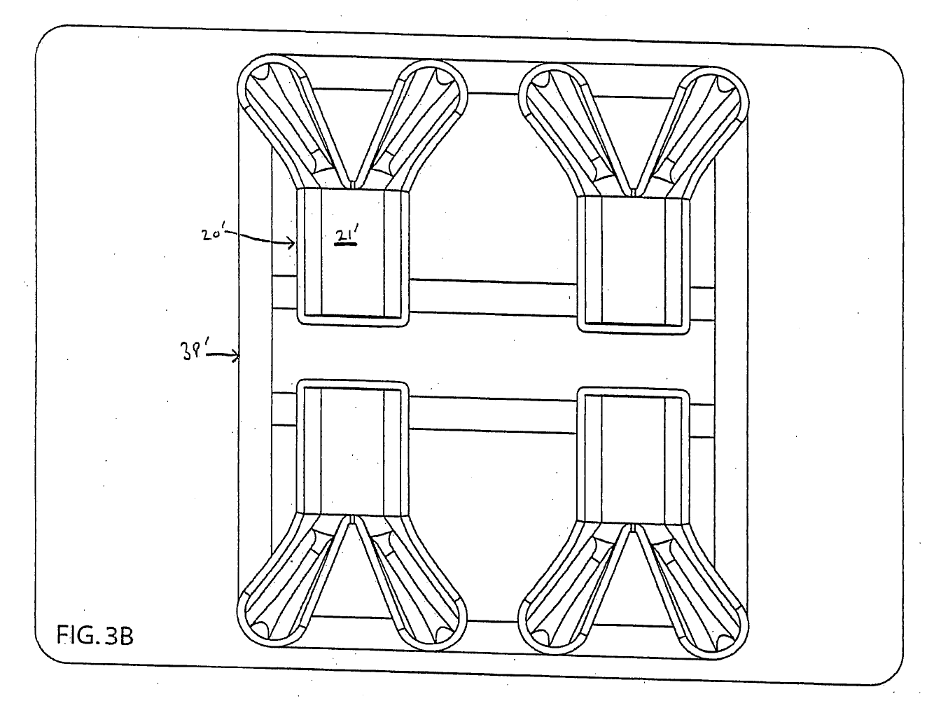

Initially, corresponding castings 42, 42′ are placed onto racks, similar to racks 38 and 38′ of FIGS. 3A and 3B respectively. The racks 38, 38′ are joined to define a rack unit for processing in a rotational molding machine. By joining the racks 38, 38′, the corresponding casting 42, 42′ are coupled together to form molds 43, with cavities 60, therein. The cavity 60 is, for example, configured in the shape of the part or product 70.

Polymer powder, such as micro-pelletized or microsphered high density polyethylene (HDPE), with pellet sizes ranging from approximately 0.0165-0.0360 inches, one such powder, for example, Esso 8760, available from Esso Chemical Company of Canada (in powder form, or micropelletized or microsphered as above), at approximately 0.230 to 0.270 grams (for example, 0.250 grams is preferred), is loaded (or placed) into the cavity 60 of each mold 43. The rack units holding the molds 43 are then processed by McNeil 800 (formerly known as a McNeil-Akron Roto-Cast™ 800) rotational molding machine (apparatus), commercially available from Ferry Industries, Inc. of Stow, Ohio, USA.

The molds 43 (as held in the respective rack units) are heated and simultaneously rotated, at speeds of approximately 6 revolutions per minute (rpm) for the inner drive rotation and 7.5 rpm for the outer drive rotation, of the rotational molding machine (apparatus) (McNeil 800 rotational molding machine). The heating, coupled with the rotation, allows the polymer powder to impinge on all internal surfaces of the mold 43 (these internal surfaces including, the surfaces 42a, 42a′ of the respective castings 42, 42′, as shown in FIG. 7, and the surface 44a of the casting 42), to form a fused layer, typically of uniform thickness. Temperatures inside the cavity 60, may be, for example, approximately 560-600° F., and cycle times are approximately 14-17 minutes.

The molds 43 are cooled while rotating, so that the plastic skin solidifies. Cooling may be by forced cold air or water spray. Once sufficiently cool, the rack units are separated into the component racks 38, 38′ allowing the molds 43 to be opened, and the parts 70 removed.

While rotational molds and methods for use thereof have been shown and described above, the present invention can easily be modified by those skilled in the art so as to be used in other molds and methods for use, such as injection molds, blow molds, and the like.

There have been shown and described apparatus and components of preferred embodiments for rotational molding. It is apparent to those skilled in the art, however, that many changes, variations, modifications, and other uses and applications for the above described embodiments are possible, and also such changes, variations, modifications, and other uses and applications which do not depart from the spirit and scope of the invention are deemed to be covered by the invention, which is limited only by the claims which follow.

What is claimed is:

1. A boss for a mold tray comprising:
a first portion extending from the surface of a portion of a mold tray; and
a second portion comprising a laterally extending segment of a mold pin, the mold pin including a longitudinal body supporting the laterally extending segment, the longitudinal body configured for being received in the first portion.

2. The boss of claim 1, wherein the first portion and the second portion are in contact with each other to conduct heat.

3. The boss of claim 2, wherein the first portion and the second portion are correspondingly shaped to be concentric and define a common periphery.

4. The boss of claim 3, wherein the first portion and the second portion are at least substantially circular in shape.

5. The boss of claim 1, wherein the first portion and the second portion are at least substantially equal in their longitudinal dimensions.

6. The boss of claim 1, wherein the mold pin additionally includes, a first end of the longitudinal body on a first side of the laterally extending segment, and, a second end of the longitudinal body on a second side of the laterally extending segment, the first end of the longitudinal body configured for receipt in at least a portion of the first portion.

7. The boss of claim 6, wherein the mold pin is an integral member.

8. The boss of claim 7, wherein the mold pin includes heat conducting material.

9. The boss of claim 8, wherein the heat conducting material includes metal.

10. A mold pin for receipt in a mold tray, comprising:
a longitudinally extending body of a rod-like shape, including a first end and a second end;
a segment extending laterally from the body and positioned along the body intermediate the first end and the second end, the laterally extending segment forming at least a portion of a boss when the mold pin is received in the mold tray.

11. The mold pin of claim 10, wherein the laterally extending segment is torroidal in shape.

12. The mold pin of claim 10, wherein the rod-like shape for the body is cylindrical.

13. The mold pin of claim 10, wherein the laterally extending segment divides the body into a first portion including the first end, and, a second portion including the second end.

14. The mold pin of claim 13, wherein the first portion is longer than the second portion.

15. The mold pin of claim 14, wherein the first portion is at least as long as the second portion.

16. The mold pin of claim 15, wherein the second portion is configured for receipt in the mold tray.

17. The mold pin of claim 10, wherein the body and laterally extending segment define an integral member.

18. The mold pin of claim 10, formed of heat conducting material.

19. The mold pin of claim 10, wherein the heat conducting material includes metal.

20. A mold system comprising:
at least one mold tray including a portion defining a portion of a mold cavity;
at least one protrusion extending from the portion of the tray defining a portion of the mold cavity;
at least one mold pin, the mold pin including a longitudinally extending rod-like shaped body including a first portion and a second portion, and a laterally extending segment, extending from the body intermediate the first portion and the second portion, the second portion for being at least temporarily received in the at least one protrusion; and
the at least one protrusion and the laterally extending segment defining at least one boss in the mold tray.

21. The mold system of claim 20, wherein the at least one mold pin is configured such that the laterally extending segment is in thermal communication with the at least one protrusion.

22. The mold system of claim 21, wherein the at least one mold pin is configured such that the laterally extending segment abuts the at least one protrusion, and, the laterally extending segment and the at least one protrusion are correspondingly shaped to be concentric, to define a common periphery.

23. The mold system of claim 22, wherein the longitudinal dimension of laterally extending segment is at least substantially equal to the longitudinal dimension of the at lest one protrusion.

24. The mold system of claim 23, wherein the at least one mold pin is an integral member.

25. The mold system of claim 24, wherein the at least one mold pin and the at least one protrusion are made of heat conducting materials.

26. The mold system of claim 25, wherein the heat conducting materials for the least one mold pin and the at least one protrusion are different materials.

27. The mold system of claim 26, wherein the heat conducting materials for the least one mold pin have a greater thermal conductivity than the material for the at least one protrusion.

28. A method for producing a molded part comprising:
providing a first mold tray including:
at least one portion defining a portion of a mold cavity;
at least one protrusion extending from the portion of the tray defining a portion of the mold cavity;
at least one mold pin, the mold pin including a longitudinally extending rod-like shaped body including a first portion and a second portion, and a laterally extending segment, extending from the body intermediate the first portion and the second portion, the second portion for being at least temporarily received in the at least one protrusion; and,
the at least one protrusion and the laterally extending segment defining at least one boss in the first mold tray;
providing a second mold tray including a portion defining a portion of the mold cavity;
placing the first mold tray and the second mold tray into alignment to define the mold cavity, and to form a mold;
placing polymer powder in the mold cavity of the mold; and,
placing the mold into a rotational molding apparatus to produce the molded part.
